(19) United States
(12) Patent Application Publication
(10) Pub. No.: US 2016/0147422 A1
(43) Pub. Date: May 26, 2016

(54) SYSTEMS AND METHODS TO DISPLAY CONTEXTUAL INFORMATION

(71) Applicant: eBay Enterprise, Inc., King of Prussia, PA (US)

(72) Inventor: Jared Blitzstein, Limerick, PA (US)

(21) Appl. No.: 14/555,107

(22) Filed: Nov. 26, 2014

(51) Int. Cl. G06F 3/0484; G06F 3/16; H04L 29/08; G06F 3/0481; G06F 3/02

(52) U.S. Cl. CPC G06F 3/04847; G06F 3/04812; G06F 3/02; H04L 67/02; G06F 3/167; G06F 3/0213

(57) ABSTRACT

Systems and methods to cause contextual information to be displayed are disclosed herein. A field may be generated. The field may be selectable to cause contextual information to be displayed. The field may be included in a section of an interface content displayed on a user device. The interface content may be viewable on the user device but the field may be hidden from view. A first keystroke may be received which moves a selection cursor to the included field. Contextual information may be displayed in response to receipt of the first keystroke. The contextual information may indicate the interface content and a second keystroke that is operable to further navigate the interface content. Further interface content may be displayed on the user device in response to receipt of the second keystroke.

### TECHNICAL FIELD

The subject matter disclosed herein generally relates to data presentation. Specifically, the present disclosure addresses systems and methods to facilitate presentation of contextual information.

### BACKGROUND

A user may use a keyboard to provide inputs in order to navigate content in an interface, such as a web page for example. By entering a specific keystroke, such as ‘tab’, may cause a cursor on the web page to move from a first position to a second position.

### BRIEF DESCRIPTION OF THE DRAWINGS

Some embodiments are illustrated by way of example and not limitation in the figures of the accompanying drawings.

FIG. 1 is a network diagram illustrating a network environment suitable for displaying contextual information, according to some example embodiments.

FIG. 2 is a block diagram illustrating components of a server machine suitable for displaying contextual information, according to some example embodiments.

FIG. 3-6 is an example user interface of a web page displayed on a user device, according to some example embodiments.

FIG. 7-9 are flowcharts illustrating operations of the server machine in performing a method of causing contextual information to be displayed, according to some example embodiments.

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems are directed to displaying contextual information. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A system may be implemented in order to assist a user that is using a keyboard of a user device to navigate content in an interface, such as a web page for example. The system may cause display of the web page on the user device. The system may also cause display of contextual information on the web page as the user provides inputs via the keyboard. The system accomplishes this by accessing hidden fields and controls in the web page. Moreover, the fields and controls cause the contextual information to be presented on a separate section of the web page. This enables the user to maintain an uninterrupted view of the web page while still being able to receive contextual information to guide the navigation of the user. Examples of contextual information may include directions on a specific keystroke that is used to trigger a specific navigation of the web page. The contextual information may also offer a preview of the contents of the web page being triggered by the specific keystrokes. Therefore, the system reduces the burden of navigating through the web page without any contextual information. This also reduces the burden on behalf of the user of having to click through each link and discovering the contents of the web page through trial and error.

Accordingly, one or more of the methodologies discussed herein may obviate a need for web page discovery without contextual information, which may have the technical effect of reducing computing resources used by one or more devices within the system. Examples of such computing resources include, without limitation, processor cycles, network traffic, memory usage, storage space, and power consumption.

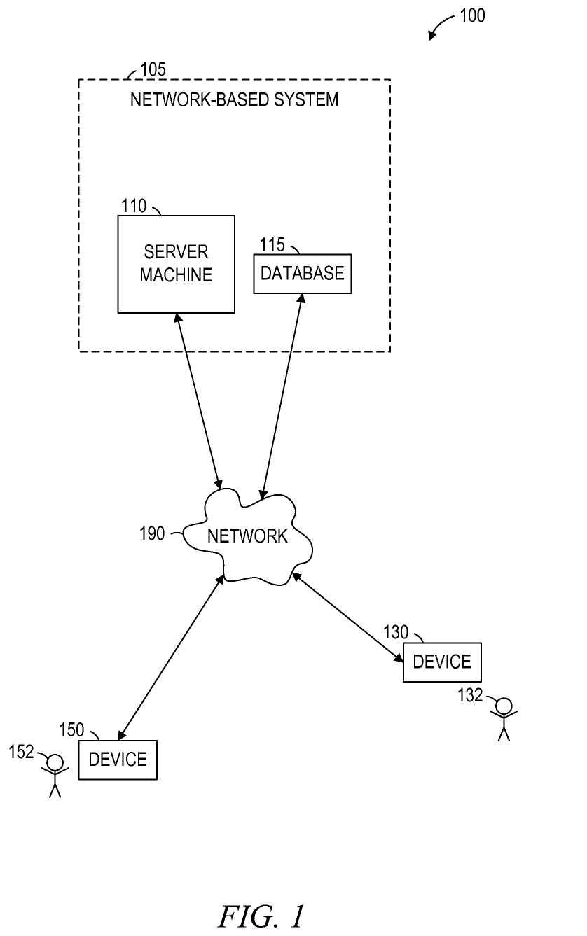

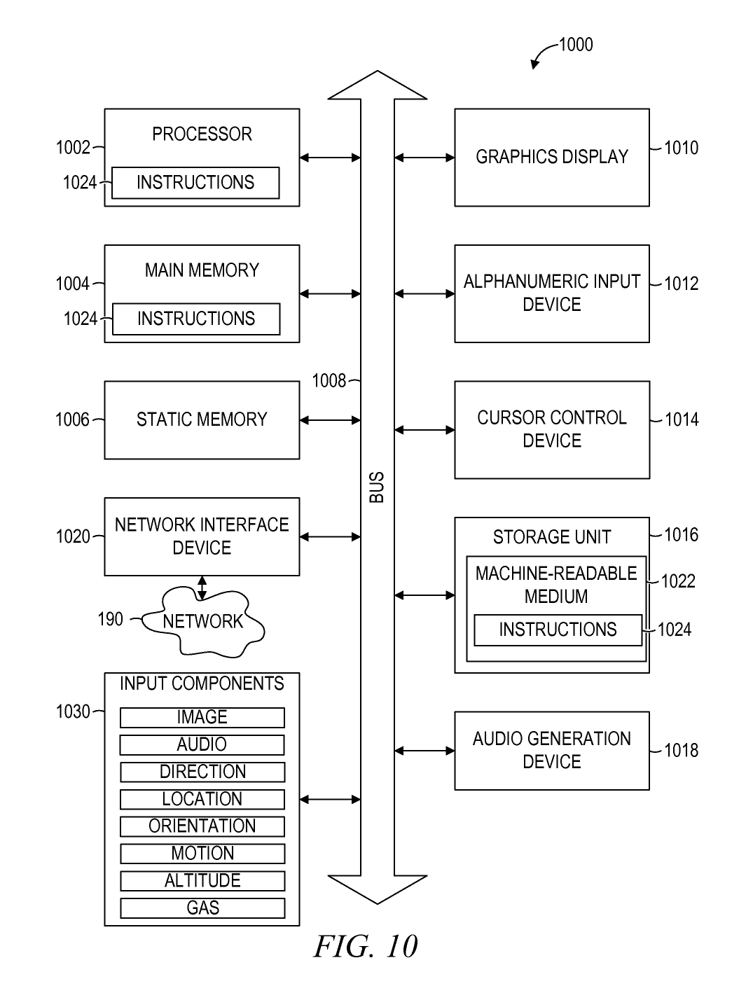

FIG. 1 is a network diagram illustrating a network environment 100 suitable for displaying contextual information, according to some example embodiments. The network environment 100 includes a server machine 110, a database 115, and devices 130 and 150, all communicatively coupled to each other via a network 190. The server machine 110 may form all or part of a network-based system 105 (e.g., a cloud-based server system configured to provide one or more services to the devices 130 and 150). The server machine 110 and the devices 130 and 150 may each be implemented in a computer system, in whole or in part, as described below with respect to FIG. 10.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

The server machine 110 may be used to assist a user (e.g., user 132, or user 152) in navigating a web page. The user may be viewing the web page on a device (e.g., device 130 or device 150). Further, the user may be using a keyboard that is coupled with device. Therefore, the user may be navigating with the web page by using the keyboard as a form of user input.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

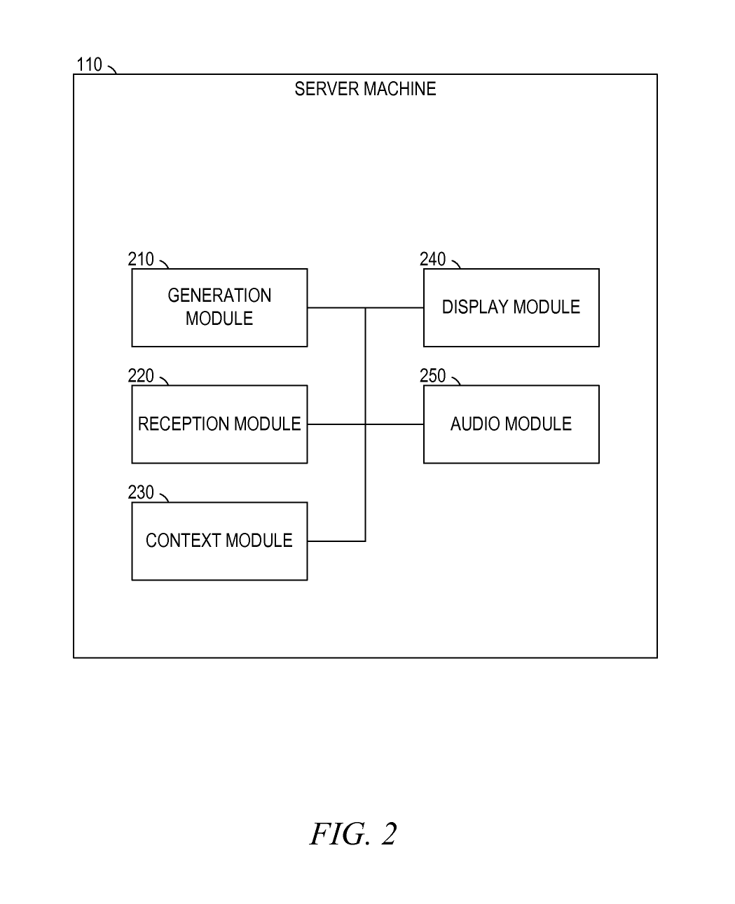

FIG. 2 is a block diagram illustrating components of the server machine 110, according to some example embodiments. The server machine 110 is shown as including a generation module 210, a reception module 220, a context module 230, a display module 240, and an audio module 250 all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the generation module 210 is configured to generate a field that is selectable to cause contextual information to be displayed or read aloud. The field may be included in interface content that is displayed within an interface. For instance, the interface content may include a web page. Moreover, the field may be included in a section of the interface content. As an example, the field may be included in a section of a web page that is displayed on a user device (e.g., device 130). In some instances, the web page may be an item page that features one or more items that are available for sale. In other words, the interface content may include the item page. Moreover, the display module 240 may be configured to cause display of the interface content that includes the generated field.

However, the field itself may be hidden from view. In other words, although the field may be included on the web page, the field will not be displayed on the user device. Moreover, the interface content (e.g., web page) remains viewable. Further, the field may contain instructions that cause the contextual information to be displayed or read aloud. As an example, the field may be a block of text or code. The block of text or code may be readable to cause the contextual information to be displayed or read aloud, as further explained below.

In various example embodiments, the generation module 210 is further configured to include the field in a section of the web page that is displayed on the user device. Therefore, although the field is hidden from view, the field may occupy the section of the web page for navigational purposes, as further explained below.

In various example embodiments, the reception module 220 is configured to receive a first keystroke that corresponds to an input from a keyboard of the user device. The first keystroke may move a selection cursor that is displayed on the web page to the included field. In other words, the first keystroke moves the selection cursor to from a previous section of the web page to the section of the web page that includes the field. As stated above, the field is included on the section of the web page by the generation module 210. The reception module 220 may be further configured to receive a second keystroke that corresponds to an input from the keyboard of the user device.

In various example embodiments, the context module 230 is configured to cause the contextual information to be displayed or read aloud in response to receipt of the first keystroke. The context module 230 may cause the contextual information to be displayed or read aloud based on the instructions contained within the generated field. As an example, if the field contains a block of code, the context module 230 may read the block of code and thereafter cause the contextual information to be displayed or read aloud. The contextual information may indicate the interface content or the contents of the web page (e.g., such as the contents of the web page nearby the section of the web page where the field is included). For instance, the contextual information may appear as a tag on the section of the web page. The tag may be used to visually distinguish the section of the web page. Moreover, the tag may include a short description about the section of the web page. In some instances, the contextual information may also indicate a second keystroke that is operable to further navigate the interface content or the contents of the web page (e.g., such as the contents of the web page nearby the section of the web page where the field is included). In some cases, the contents of the web page may already be displayed on the user device. Accordingly, navigation of the contents of the web page may include zooming in on a section of the web page where the field is included. Navigation of the contents of the web page may also include further visually distinguishing the section of the web page where the field is included. In the case the web page is an item page, the navigation of the contents of the web page may include visually distinguishing portions of the item page that display information about the one or more items. In other instances, the contents of the web page may be displayed by the display module 240 upon receipt of the second keystroke (e.g., an image carousel), as further explained below.

In some instances, the context module 230 is further configured to cause display of contextual information that indicates a further keystroke that is operable to perform an action with respect to the one or more items featured in the item page. For example, the context module 230 may indicate a bid keystroke that is operable to place a bid on the one or more items featured in the item page. The context module 230 may also indicate a purchase keystroke that is operable to purchase the one or more items featured in the item page. The context module 230 may also indicate a view item keystroke that is operable to view the one or more items featured in the item page.

In various embodiments, the context module 230 is configured to cause the contextual information to be displayed on a further section of the web page that is separate from the section of the web page where the field is included. For instance, the contextual information may be displayed below the section of the web page where the field is included. In some instances, the contextual information may appear in a separate pop up window that is displayed over the section of the web page where the field is included.

In various example embodiments, the audio module 250 is configured to cause the contextual information to be read aloud in response to receipt of the received first keystroke. For instance, the audio module 250 may generate audio data and then send the audio data to the user device in order to have the contextual information be read aloud on the user device. As stated previously, the contextual information may indicate a second keystroke that is operable to further navigate the contents of the web page. Upon hearing the contextual information, the user (e.g., user 132) may respond by inputting the second keystroke. In the case that the web page is an item page, the context module 230 may read aloud the item attributes of the one or more items as part of the contextual information.

Upon receipt of the second keystroke at the reception module 220, the display module 240 is configured to cause the further interface content to be displayed on the user device. In some embodiments, the display module 240 causes the contents of the web page to be displayed on the user device, in various example embodiments. In some instances, the contents of the web page may be a pop-up window that is displayed upon receipt of the second keystroke. For example, the contents of the web page may include an image carousel that is displayed after being triggered by the receipt of the second keystroke at the reception module 220. Moreover, each of the images from the image carousel may be selectable upon receipt of a further keystroke from the user device. For instance, in the case that the web page is an item page, the images from the image carousel may be images of the one or more items featured in the item page. Moreover, the display module 240 may display item attributes for any of the one or more items featured in the item page. For example, the display module 240 may provide a description of the one or more items featured in the item page. The description may provide attribute information such as color of the one or more items, size of the one or more items, and the like. In some instances, the item attributes for any of the one or more items may be displayed as part of the contextual information. In some instances, the second keystroke triggers a link that is used to retrieve the contents of the web page.

In various example embodiments, the display module 240 is further configured to cause a zoom in on a section of the web page. For instance, the display module 240 may zoom in on the section of the web page where the field is included. The display module 240 may be further configured to visually distinguish portions of the item page the section of the web page where the field is included. For instance, if the field is included in a section of the web page that displays information about the one or more items, the display module 240 is further configured to visually distinguish portions of the item page that displays information about the one or more items.

In various example embodiments, the display module 240 is further configured to cause display of a result on the web page (e.g., item page) that corresponds to the action being performed with respect to the one or more items featured in the item page. As an example, if the action being performed is a bid on an item, the display module 240 may display a result that shows that the bid is successfully entered for the item. As another example, if the action being performed is a purchase of an item, the display module 240 may display a result that shows that the purchase of the item has been entered. The display module 240 is further configured to cause the display of the result in response to receipt of the further keystroke as indicated by the context module 230.

In various example embodiments, the display module 240 is further configured to display the selection cursor on a separate section of the web page prior to receiving the first keystroke. The selection cursor may be viewable by the user on the user device. In other words, the selection cursor may appear as part of the web page. The display module 240 may also conceal the selection cursor upon moving the selection cursor to the field in order to hide the selection cursor from view. As explained earlier, the generated field is hidden from view. Therefore, in some instances, when the selection cursor is moved over to the generated field, the display module 240 will conceal the selection cursor.

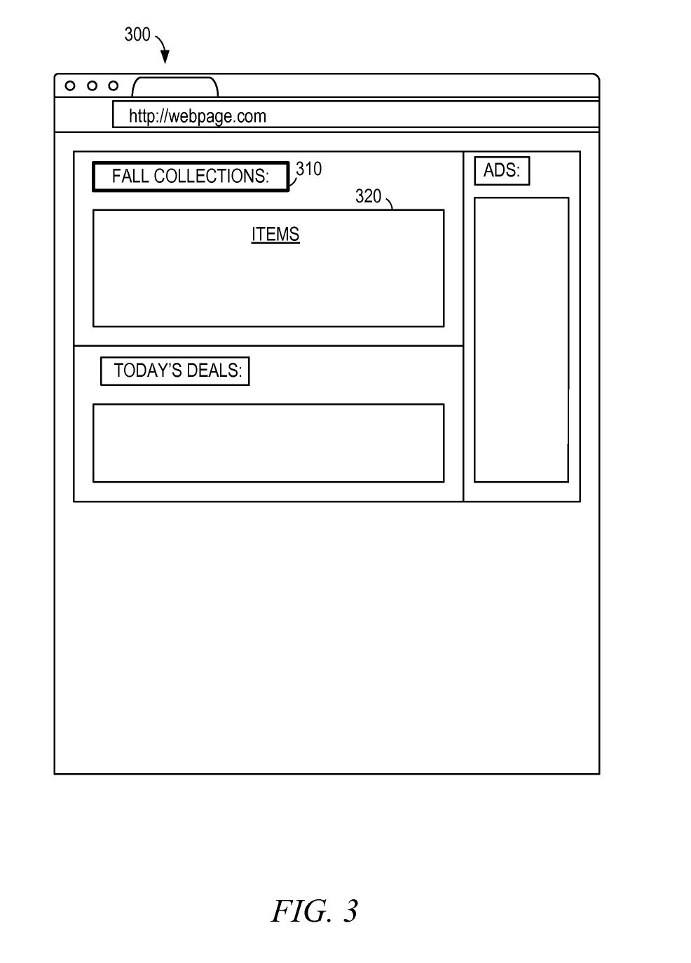

FIG. 3 is an example user interface 300 of a web page displayed on a user device, according to some example embodiments. The user interface 300 may include a selection cursor appearing at section 310 of the web page that displays a title “fall collections.” The selection cursor may be bolded in order to indicate its location on the web page to a user viewing the web page. Further, the selection cursor may be moved from section 310 of the web page to section 320 of the web page. A generated field may be included in section 320 of the web page. However, the generated field may be hidden from view and therefore not shown in the example user interface 300. The selection cursor 310 may also be moved to section 320 upon receipt of a first keystroke from a keyboard of the user device. The generated field may contain instructions which cause contextual information to be displayed. The context module 230 may be used to read the instructions and thereafter display the contextual information.

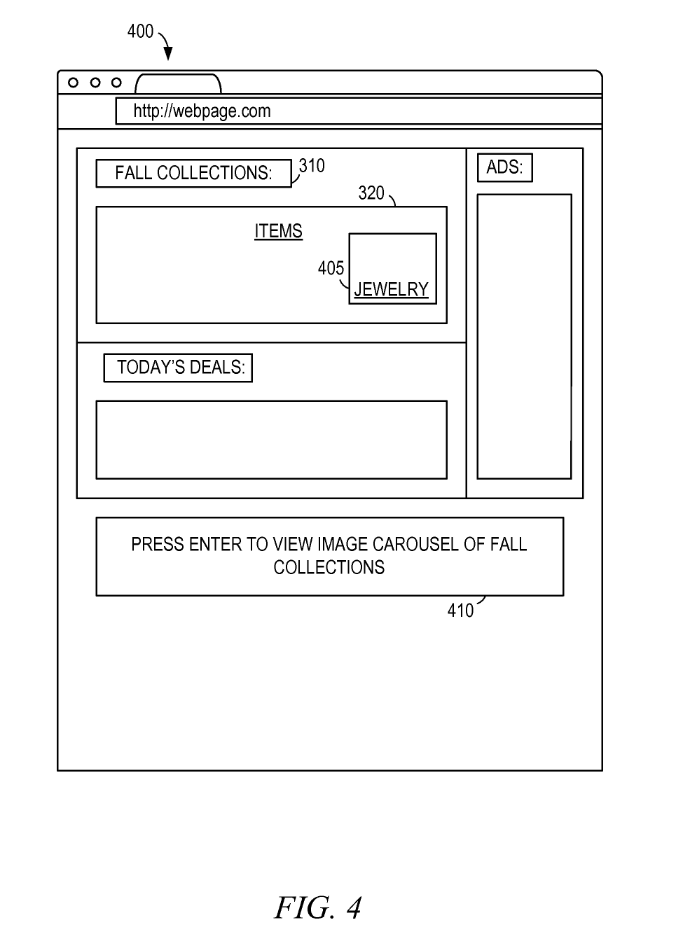

FIG. 4 is an example user interface 400 of a web page displayed on a user device, according to some example embodiments. The user interface 400 may be displayed on the user device in response to receipt of a first keystroke from the user device. The first keystroke may move the selection cursor to section 320 of the web page. As a result, section 310 does not appear as bolded as it did in FIG. 3 because the selection cursor has moved from section 310 to section 320. Contextual information 410 may be displayed in response to movement of the selection cursor to section 320 of the web page. The contextual information 410 indicates a second keystroke that is operable to view or navigate contents of the web page. Although not shown in FIG. 4, in some instances, the contextual information 410 may be read aloud as audio data for a user to hear. Also shown in FIG. 4 is contextual information 405 that appears on the section 320 of the web page. The contextual information 405 may be a tag that is used to identify items that are displayed in the section 320 of the web page. For instance, the section 320 of the web page may include jewelry items and accordingly, the contextual information 405 includes a short description (“JEWELRY”).

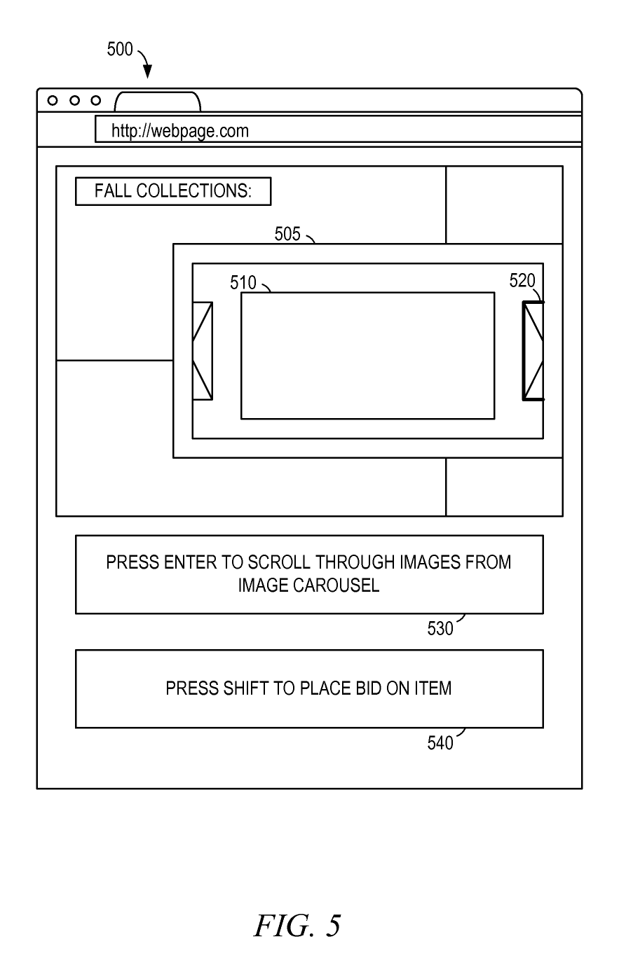

FIG. 5 is an example user interface 500 of a web page displayed on a user device, according to some example embodiments. The user interface 400 may be displayed on the user device in response to receipt of the second keystroke from the user device. The second keystroke is indicated as part of the contextual information 410 of FIG. 4. As shown, the user interface 500 includes an image carousel 505. Moreover, the image carousel 505 also features an image 510 of an item. The user interface 500 may also include contextual information 530 that indicates a keystroke that is operable to view or navigate the image carousel 505. Also shown in the user interface 500 is a selection cursor that is used to navigate the image carousel 505. The selection cursor may appear bolded at section 520 of the web page for navigational purposes. Also included in the user interface 500 is additional contextual information 540 that indicates a further keystroke that is operable to place a bid on an item depicted in the image 510.

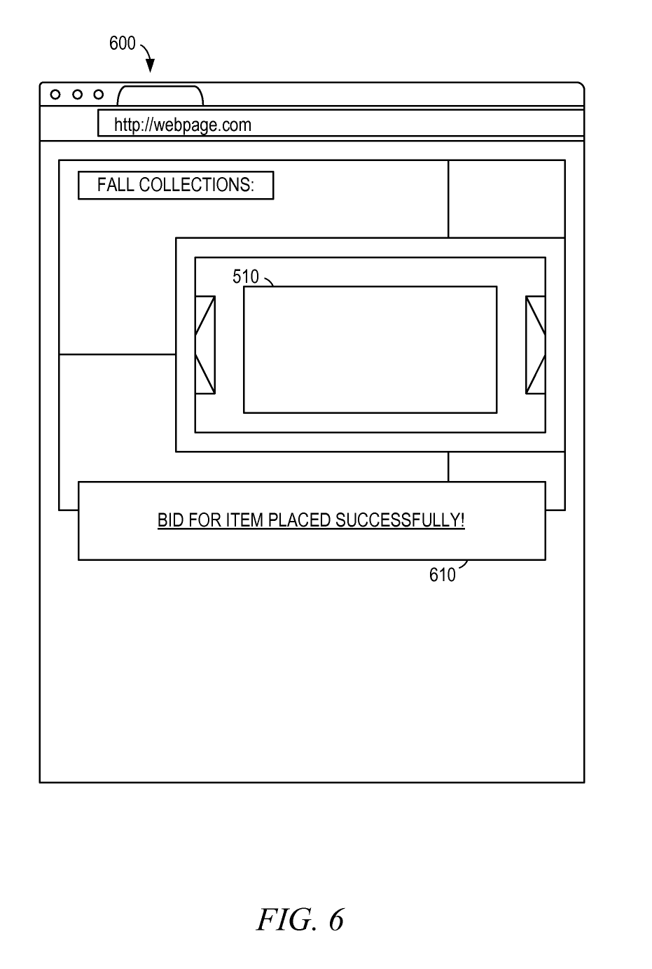

FIG. 6 is an example user interface 600 of a web page displayed on a user device, according to some example embodiments. The example user interface 600 may include an image carousel that displays the image 510 of the item that was also displayed in FIG. 5. Further, the user interface 600 may include a message 610 that displays an action being performed with respect to the item displayed in the image 510. As shown in FIG. 6, the message 610 indicates that a bid has been successfully placed for the item shown in the image 510. The example user interface 600 may be displayed as a result of the further keystroke being operated by the user and as indicated in the additional contextual information 540 of FIG. 5.

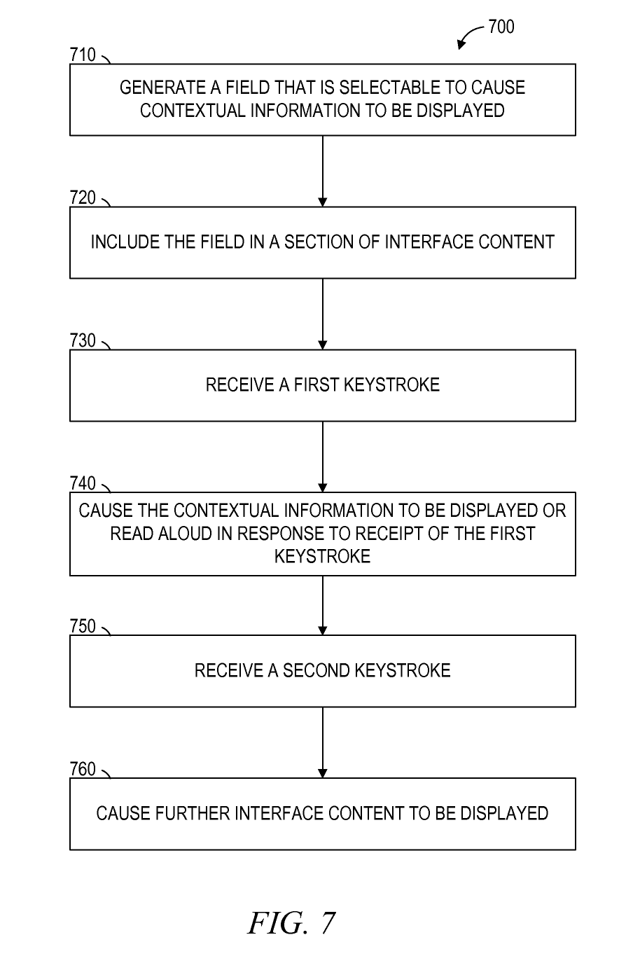

FIG. 7-9 are flowcharts illustrating operations of the server machine 110 in performing a method 700 of causing contextual information to be displayed, according to some example embodiments. Operations in the method 700 may be performed by the server machine 110, using modules described above with respect to FIG. 2. As shown in FIG. 7, the method 700 includes operations 710, 720, 730, 740, 750, and 760.

At operation 710, the generation module 210 generates a field that is selectable to cause contextual information to be displayed. The field is for inclusion in interface content. The field itself may be hidden from view. Further, the field may contain instructions that cause the contextual information to be displayed or read aloud. As an example, the field may be a block of text or code. The block of text or code may be readable to cause the contextual information to be displayed or read aloud. The contextual information is used to help facilitate navigation of the web page for a user.

At operation 720, the generation module 210 includes the field in a section of the interface content that is displayed on a user device. The user may be operating the user device.

At operation 730, the reception module 220 receives a first keystroke that corresponds to an input from a keyboard of the user device. The first keystroke may be used to move a selection cursor to the section of the interface content where the field is included.

At operation 740, the context module 230 causes the contextual information to be displayed in response to receipt of the first keystroke at operation 730. The contextual information may indicate the interface content. The contextual information may also indicate a second keystroke that is operable to further navigate the interface content. In some instances, the contextual information is a tag that appears on the interface content. The tag may include a description of the interface content.

At operation 750, the reception module 220 receives a second keystroke that corresponds to an input from the keyboard of the user device. The second keystroke may correspond to the keystroke that was indicated by the context module 230 in the operation 740.

At operation 760, the display module 240 causes further interface content to be displayed. In some instances, the further interface content may be a pop-up window that is displayed, such as an image carousel.

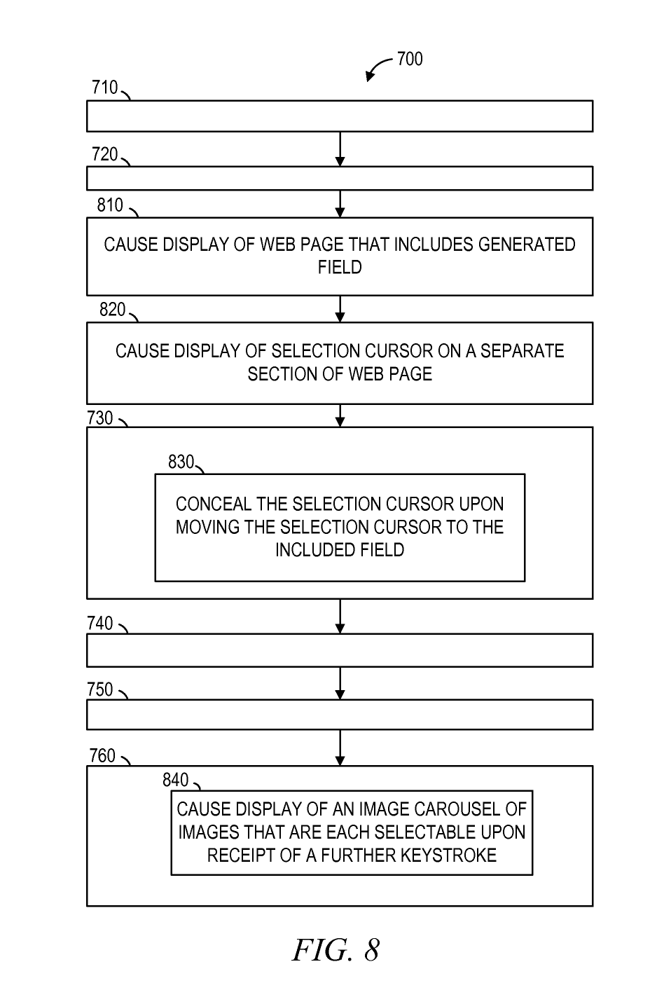

As shown in FIG. 8, the method 700 may include one or more of operations 810, 820, 830, and 840.

At operation 810, the display module 240 causes display of the web page that includes the generated field. As stated above, the interface content may include a web page. The operation 810 may be performed after operation 720 but prior to the operation 740. As previously mentioned, the web page may be an item page that features one or more items that are available for sale. For instance, the item page may be a catalogue that displays a seasonal collection of items that are newly available.

At operation 820, the display module 240 causes display of a selection cursor on a separate section of the web page. For example, the selection cursor may be shown at a location that is different from the section of the web page where the generated field is included. The operation 820 may be performed prior to the operation 630.

At operation 830, the display module 240 conceals the selection cursor upon moving the selection cursor to the included field. The operation 820 may be performed as part of the operation 630. As explained before, the field may be hidden from view. Therefore, when the selection cursor is moved to the field, then the selection cursor is concealed by the display module 240 in order to prevent the field from being shown.

At operation 840, the display module 240 causes display of an image carousel of images that are each selectable upon receipt of a further keystroke. The operation 830 may be performed as part of the operation 660. Moreover, in the case that the web page is an item page, the images from the image carousel may be images of the one or more items featured in the item page.

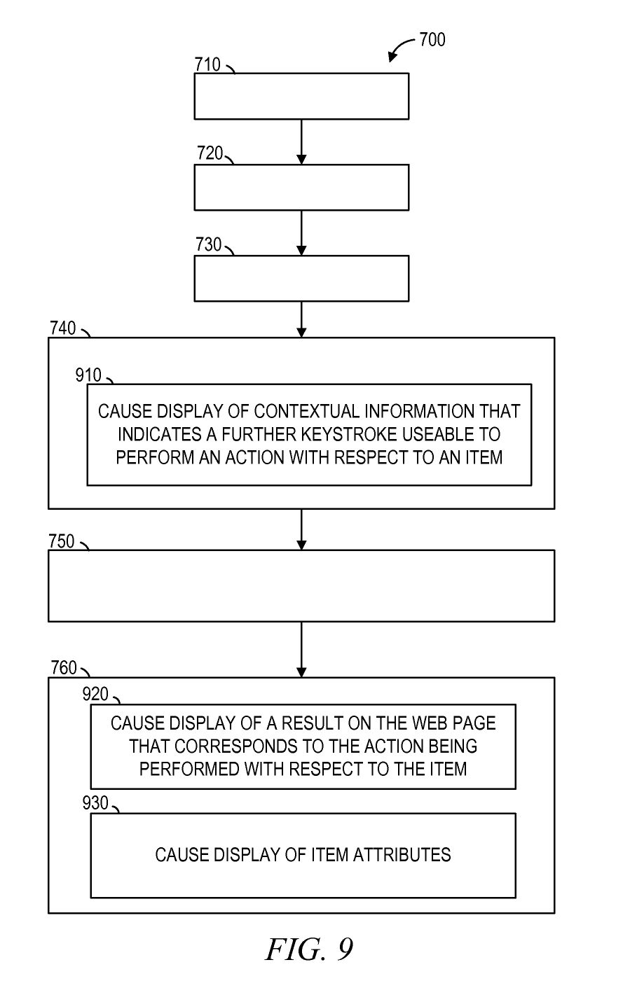

As shown in FIG. 9, the method 700 may include one or more of operations 910, 920, and 930.

At operation 910, the context module 230 causes display of contextual information that indicates a further keystroke useable to perform an action with respect to an item. As explained earlier, the web page may be an item page that features the item. The operation 910 may be performed as part of the operation 640. Actions may include placing a bid on the item, purchasing the item, viewing the item, and the like.

At operation 920, the display module 240 causes display of a result on the web page that corresponds to the action being performed with respect to the item. The result may correspond to the action that was requested in the operation 910.

At operation 930, the display module 240 causes display of item attributes for the item. For instance, the item attributes may include color of the item, size of the item, and the like.

According to various example embodiments, one or more of the methodologies described herein may facilitate display of contextual information. Moreover, one or more of the methodologies described herein may facilitate display of contents of a web page.

When these effects are considered in aggregate, one or more of the methodologies described herein may obviate a need for certain efforts or resources that otherwise would be involved in navigating a web page. Efforts expended by a user in web page discovery may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 10 is a block diagram illustrating components of a machine 1000, according to some example embodiments, able to read instructions 1024 from a machine-readable medium 1022 (e.g., a non-transitory machine-readable medium, a machine-readable storage medium, a computer-readable storage medium, or any suitable combination thereof) and perform any one or more of the methodologies discussed herein, in whole or in part. Specifically, FIG. 10 shows the machine 1000 in the example form of a computer system (e.g., a computer) within which the instructions 1024 (e.g., software, a program, an application, an applet, an app, or other executable code) for causing the machine 1000 to perform any one or more of the methodologies discussed herein may be executed, in whole or in part.

In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include any collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The processor 1002 may contain microcircuits that are configurable, temporarily or permanently, by some or all of the instructions 1024 such that the processor 1002 is configurable to perform any one or more of the methodologies described herein, in whole or in part. For example, a set of one or more microcircuits of the processor 1002 may be configurable to execute one or more modules (e.g., software modules) described herein.

The machine 1000 may further include a graphics display 1010 (e.g., a plasma display panel (PDP), a light emitting diode (LED) display, a liquid crystal display (LCD), a projector, a cathode ray tube (CRT), or any other display capable of displaying graphics or video). The machine 1000 may also include an alphanumeric input device 1012 (e.g., a keyboard or keypad), a cursor control device 1014 (e.g., a mouse, a touchpad, a trackball, a joystick, a motion sensor, an eye tracking device, or other pointing instrument), a storage unit 1016, an audio generation device 1018 (e.g., a sound card, an amplifier, a speaker, a headphone jack, or any suitable combination thereof), and a network interface device 1020.

The storage unit 1016 includes the machine-readable medium 1022 (e.g., a tangible and non-transitory machine-readable storage medium) on which are stored the instructions 1024 embodying any one or more of the methodologies or functions described herein. The instructions 1024 may also reside, completely or at least partially, within the main memory 1004, within the processor 1002 (e.g., within the processor's cache memory), or both, before or during execution thereof by the machine 1000. Accordingly, the main memory 1004 and the processor 1002 may be considered machine-readable media (e.g., tangible and non-transitory machine-readable media). The instructions 1024 may be transmitted or received over the network 190 via the network interface device 1020. For example, the network interface device 1020 may communicate the instructions 1024 using any one or more transfer protocols (e.g., hypertext transfer protocol (HTTP)).

In some example embodiments, the machine 1000 may be a portable computing device, such as a smart phone or tablet computer, and have one or more additional input components 1030 (e.g., sensors or gauges). Examples of such input components 1030 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1024 for execution by the machine 1000, such that the instructions 1024, when executed by one or more processors of the machine 1000 (e.g., processor 1002), cause the machine 1000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. As used herein, the term “or” may be construed in either an inclusive or exclusive sense.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
generating a field for inclusion in interface content, the field being selectable to cause contextual information to be displayed in the interface, the field containing instructions that cause the contextual information to be displayed in the interface;
including the field in a section of the interface content displayed on a user device, the interface content being viewable on the user device but the field being hidden from view;
receiving a first keystroke that moves a selection cursor to the included field, the first keystroke corresponding to an input from a keyboard of the user device;
causing the contextual information, using one or more processors, to be displayed in response to receipt of the received first keystroke that moves the selection cursor to the included field and based on the instructions contained within the included field, the displayed contextual information indicating the interface content and indicating a second keystroke that is operable to further navigate the interface content; and
causing further interface content to be displayed on the user device in response to receipt of the second keystroke from the user device.

2. The method of claim 1, further comprising:
causing the contextual information to be read aloud in response to receipt of the received first keystroke and based on the instructions contained within the field.

3. The method of claim 1, further comprising:
receiving the second keystroke that corresponds to an input from the keyboard of the user device.

4. The method of claim 1, further comprising:
displaying the selection cursor on a separate section of the interface content prior to receiving the first keystroke, the selection cursor being viewable on the user device.

5. The method of claim 4, further comprising:
concealing the selection cursor upon moving the selection cursor to the field in order to hide the selection cursor from view.

6. The method of claim 1, wherein the causing the further interface content to be displayed includes causing display of an image carousel of images that are each selectable upon receipt of a further keystroke from the user device.

7. The method of claim 1, wherein the interface content includes an item page, and wherein the causing the further interface content to be displayed includes causing display of item attributes for the item.

8. The method of claim 1, wherein the interface content includes an item page, and wherein the causing the contextual information to be displayed includes causing display of contextual information that indicates a further keystroke that is operable to perform an action with respect to an item of the item page.

9. The method of claim 8, further comprising:
displaying a result in the interface that corresponds to the action being performed with respect to the item of the item page in response to receipt of the further keystroke.

10. The method of claim 1, wherein the causing the contextual information to be displayed includes causing the contextual information to be displayed on a further section of the interface content that is separate from the section of the interface content.

11. The method of claim 1, further comprising:
prior to receiving the first keystroke, causing display of the interface content that includes the generated field on the user device.

12. A system comprising:
a generation module configured to:
generate a field for inclusion in interface content, the field being selectable to cause contextual information to be displayed in the interface, the field containing instructions that cause the contextual information to be displayed in the interface; and
include the field in a section of the interface content displayed on a user device, the interface content being viewable on the user device but the field being hidden from view;
a reception module configured to receive a first keystroke that moves a selection cursor to the included field, the first keystroke corresponding to an input from a keyboard of the user device;
a context module configured to cause contextual information to be displayed in response to receipt of the received first keystroke that moves the selection cursor to the included field and based on the instructions contained within the included field, the displayed contextual information indicating the interface content and indicating a second keystroke that is operable to further navigate the interface content; and
a display module configured to cause further interface content to be displayed on the user device in response to receipt of the second keystroke from the user device.

13. The system of claim 12, further comprising an audio module configured to cause the contextual information to be read aloud in response to receipt of the received first keystroke and based on the instructions contained within the field.

14. The system of claim 12, wherein the reception module is further configured to receive the second keystroke that corresponds to an input from the keyboard of the user device.

15. The system of claim 12, wherein the display module is further configured to display the selection cursor on a separate section of the interface content prior to receiving the first keystroke, the selection cursor being viewable on the user device.

16. The system of claim 12, wherein the display module is further configured to conceal the selection cursor upon moving the selection cursor to the field in order to hide the selection cursor from view.

17. The system of claim 12, wherein the display module is further configured to cause display of an image carousel of images that are each selectable upon receipt of a further keystroke from the user device.

18. The system of claim 12, wherein the interface content includes an item page, and wherein the display module is further configured to cause display of contextual information that indicates a further keystroke that is operable to perform an action with respect to an item of the item page.

19. The system of claim 18, wherein the display module is further configured to display a result in the interface that corresponds to the action being performed with respect to the item of the item page in response to receipt of the further keystroke.

20. A non-transitory machine-readable medium storing instructions that, when executed by one or more processors of a machine, cause the machine to perform operations comprising:
generating a field for inclusion in interface content, the field being selectable to cause contextual information to be displayed in the interface, the field containing instructions that cause the contextual information to be displayed in the interface;
including the field in a section of the interface content displayed on a user device, the interface content being viewable on the user device but the field being hidden from view;
receiving a first keystroke that moves a selection cursor to the included field, the first keystroke corresponding to an input from a keyboard of the user device;
causing the contextual information to be displayed in response to receipt of the received first keystroke that moves the selection cursor to the included field and based on the instructions contained within the included field, the displayed contextual information indicating the interface content and indicating a second keystroke that is operable to further navigate the interface content; and
causing further interface content to be displayed on the user device in response to receipt of the second keystroke from the user device.
